(19) United States
(12) Patent Application Publication
(10) Pub. No.: US 2011/0140880 A1
(43) Pub. Date: Jun. 16, 2011

(54) Power delivery with power source identification

(76) Inventor: Allen Gerber, High Falls, NY (US)

(21) Appl. No.: 12/653,331

(22) Filed: Dec. 11, 2009

(51) Int. Cl. G08B 1/08

(52) U.S. Cl. 340/538

(57) ABSTRACT

A system and method is described in which energy source identification information is impressed upon electrical conductors employed in an electrical energy distribution network. The present invention negates the concept that electrical energy in a power distribution system is or should be treated as a fungible quantity. The present invention provides a mechanism by which end-users are rendered capable of determining and requesting that the electrical energy being provided to them is derived from renewable resources in general or from specific renewable resources. The present invention also enhances the capabilities for monitoring and controlling the production of greenhouse gases, particularly carbon dioxide.

### TECHNICAL FIELD

The present invention is generally directed to electrical power generation and distribution. More particularly, the present invention is directed to power line communications which provide signal transmissions over the electrical grid or network. Even more particularly, the present invention is directed to adding signal level information to the transmission of electrical power in a manner which indicates the source of the power and which can thus identify the electrical power being supplied from amongst solar, wind, nuclear, fossil fuel or other specific sources.

### BACKGROUND OF THE INVENTION

The issues associated with global warming have led to a desire to produce electrical energy from renewable sources and from resources which do not produce significant levels of carbon dioxide (CO₂). While some renewable sources of energy do result in the production of CO₂, their production from biofuels (corn based, algae based, switch grass based, etc.) tend to be a lot more “carbon neutral” in the long run than fossil fuels such as petroleum and coal. For sources of electrical power that are most carbon neutral in the production of electrical energy, the world has looked to solar photovoltaics, wind turbines, tidal and wave conversion and nuclear energy. In terms of nuclear energy the present invention is applicable to use with any nuclear power source be it fusion or fission, and, if fission, one based on a uranium cycle or a thorium cycle. Even more to the point, the present invention is applicable to any source of electrical power and provides a mechanism for identifying the source and nature of the power generation system.

However, the power that is delivered to our homes and to the various substations in the electrical grid comes with no mechanism to determine who produced it, where it was produced or to what extent it may have contributed to the addition of CO₂ to the atmosphere. Furthermore, consumers of electrical power at all levels along the grid have no way to specify any preference whatsoever for an electrical energy source or even for a specified mix of sources. If consumers could specify a source and if they could be assured that the energy they were being supplied was of the desired value, it is believed that this choice would assist in pushing the drive to more environmentally friendly sources of energy. Energy and power are not used synonymously herein since power is merely the rate at which energy is being supplied. The ultimate cost to the energy customer is the amount of energy used, a quantity usually measured in kilowatt-hours.

As presently provided and delivered, electrical energy is a fungible quantity. There is little distinction made, at least on a gross scale, as to the mechanism for its production. While it is true that the producers of electrical power can tailor the source mix based upon current demand, it is impossible for the consumer or intermediate transmitter of electrical energy to discern, on a moment to moment basis, the power source that generated the electrical energy. Thus, it is seen that a power company is able to quickly activate a hydroelectric facility to match peak demands. However, and consumers of electrical energy have little or no dynamic control over the source of that energy. In particular, it is noted that those consumers who would like to see a higher mix of renewable resources used in their homes, there is no easy mechanism for such a request to be made.

Likewise, governmental agencies are ill-equipped to discern the specific nature of the electrical power being delivered in any given state, region or area. Accordingly, if it were decided that a certain percentage of electrical energy was required to be produced from, say photovoltaic sources, it would be impossible for such controls to be imposed, especially in a dynamic modality. Such control is nonetheless desirable for several reasons. In particular, should it be discerned that atmospheric conditions including smog, acidity, carbon dioxide level and particulate concentrations were too high, it would be desirable for governmental control agencies to mandate a shift in energy generation sources on a relatively short timescale. At the moment, there is absolutely no coupling between local or regional atmospheric conditions and the generation of electrical energy.

The present invention also provides an advantage in that other points of information concerning energy sources is now made available for the long term generation of scientific data. The present invention provides a mechanism for data generation, data monitoring and data collection. This information is intended to provide baseline and future information for the purpose of tracking trends in energy generation, transmission, delivery and usage. All of these notions are in keeping with what many have referred to as the “smart grid.”

In addition to tracking the sources of electrical energy production in an electrical energy distribution system, the present invention is also capable of tracking and estimating by source the amount of carbon dioxide produced. The present invention thus provides a dynamic, short time scale indication of carbon dioxide production. As such the present invention is employable as part of an economic system in which carbon dioxide production occurs in a so-called cap and trade protocol. Since the present invention is designed to include security aspects, the present invention is thus capable of operating on relatively short time scales. More specifically, it is seen that the present invention provides an information feedback mechanism which provides a more intelligent, economic, efficient, and ecologically greener electrical energy delivering network.

It is furthermore noted that the uses and advantages of the present invention extend beyond those of merely monitoring, controlling, and tracking the source of electrical energy. The present invention also provides a mechanism under which energy generating entities are provided with incentives for the production of “premium” energy, that is energy derived from renewable resources such as solar, wind, tidal and geothermal. Additionally, energy generating entities may be provided with a distribution quota for various forms of energy production. These quotas may be exchanged between such entities in a manner similar to the so-called cap and trade systems associated with greenhouse gas production. For example, an energy producer in the Southwest United States would be allocated a high quota for the production of photovoltaically produced electrical energy. Such a producer is envisioned as being able to have an incentive to exceed this quota and to thus “sell or trade” the excess to an electrical energy producer in the northeastern United States where sunshine is less prevalent. It is furthermore noted that this “cap and trade” mechanism is not limited to a single country. Its utilization is extendable worldwide. This is significant since it is clear that the generation of greenhouse gases not only occurs on a worldwide basis but is also a worldwide problem. The ability of the present invention to identify, on a dynamic basis, the source of electrical energy is a key element in any such international system of capping and trading electrical energy production. The presentation is also useful in establishing electrical energy as a standard commodity, known in used worldwide, in much the same manner that gold and other precious metals provide bases for standards. In this way the present invention operates to foster electrical energy production as a standard operating in parallel with other economic standards relating to limited resources. Commodities that are limited in this way such as gold and monetary values have throughout the course of human history been seen to function well as standards for economy and trading. In the present instance, the use of “identified electrical energy” operates not only as a standard but also operates as a standard which fosters and promotes a greener and safer environment.

It is also noted that in the operation of the present invention, the information generated and transmitted via the system disclosed herein is intended for Internet posting so as to provide the greatest degree of transparency, especially for end users of electrical energy.

From the above, it is therefore seen that there exists a need in the art to overcome the deficiencies and limitations described herein and above.

### SUMMARY OF THE INVENTION

The shortcomings of the prior art are overcome and additional advantages are provided through a system and method in which electrical energy carrying lines also include a signal indicating the mix of energy sources which have contributed to the energy being supplied. Accordingly, a method of providing electrical energy comprises: generating the electrical energy; transmitting the electrical energy generated from a source to a destination via an electrical energy transmission network; specifying an energy source indicator for the generated energy; and transmitting the indicium over said transmission network along with the energy.

The energy source indicator includes encoded information which identifies the nature of the power source. More particularly, energy source identification includes such sources as: solar photovoltaic, wind, tidal, geothermal, solar thermal, nuclear fusion, nuclear fission, coal, oil, natural gas, biofuel, hydrogen, etc. Furthermore, as future sources of energy become available, it is contemplated that they too are provided with a indicium of its nature. Moreover, the present invention also includes transmitted information that includes, in appropriate cases, subtypes of power source generation modalities. For example, if one field in the transmitted signal indicates “coal,” then there is also provided a subfield which more particularly represents any one of the following subtypes: anthracite coal, bituminous coal or peat.

The identifying signal also preferably contains other identifying information. In particular, there is provided a field which indicates a serial number which indicates a particular source per its owner and/or location. For example, every solar panel may include its own unique identifier. Every oil fired generating plant is also preferably provided with a unique identifier in addition to a indicium that the energy that it generates is from oil.

In accordance with other embodiments of the present invention there is also provided a system for insuring that the source of power is correctly identified.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a block diagram illustrating in a high-level fashion a network for the distribution of electrical energy in which the energy on the grid is derived from a plurality of sources and is distributed in a mix to a plurality of customers through a tree structure of substations and sub-substations;

FIG. 2 is a block diagram illustrating the structure of the information fields that are provided in various embodiments of the present invention most notably there being a field indicating energy source;

FIG. 3 is a block diagram illustrating for a single power generating source a system for impressing upon the conductors carrying electrical energy a separate signal carrying information about the nature of the electrical energy source;

FIG. 4 is a block diagram illustrating a system and method for providing secure control of the source identifying information imposed upon the network of electrical energy carrying conductors;

FIG. 5 is a block diagram illustrating the operation of the present invention as it is employed at any one of these substations within the electrical energy network; and

FIG. 6 is an illustration depicting a solar photovoltaic panel in which a portion thereof is dedicated to providing an identifying signal to be transmitted to the electrical energy grid along with the energy itself.

### DETAILED DESCRIPTION

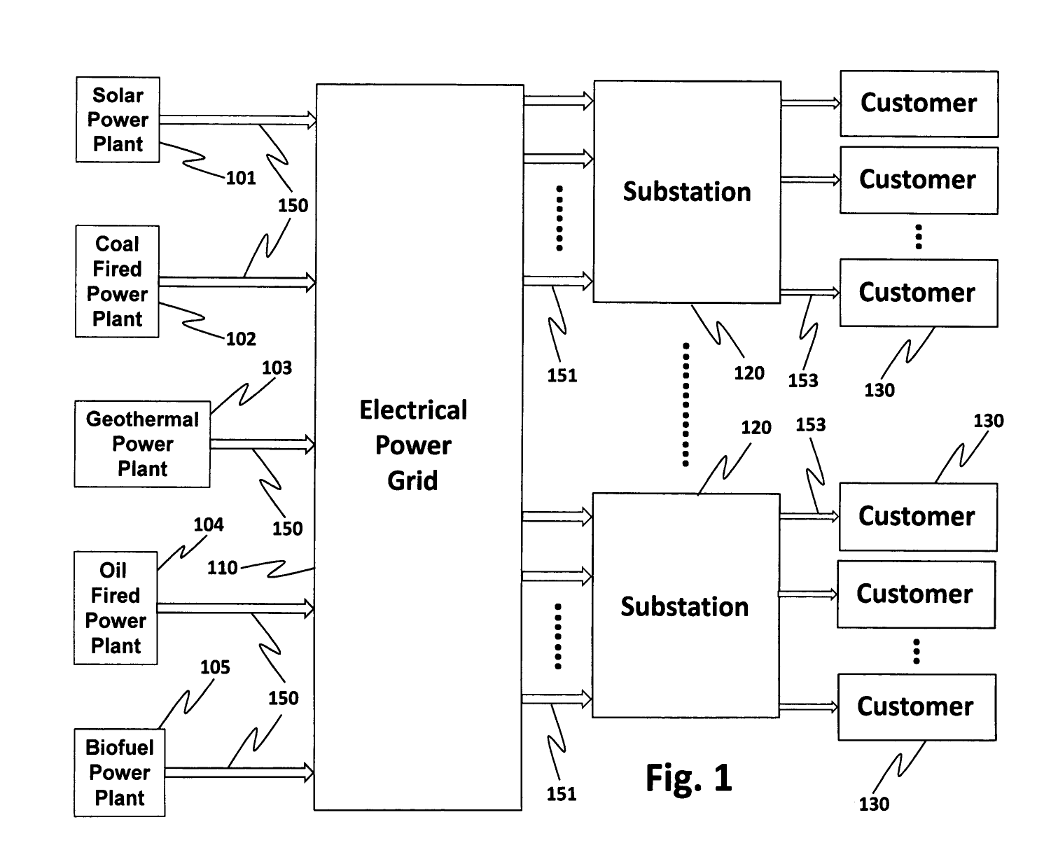

FIG. 1 illustrates the kind of electrical energy grid or network in which the present invention is most likely to be used and which is most ripe for the energy monitoring functions described herein. In particular, it is noted that any particular system shown there exists the possibility that electrical energy is supplied to electrical power grid 110 from a plurality of individual sources. These sources include solar power plant 101, coal fired plant 102, geothermal power plant 103, oil fired power plant 104 and biofuel power plant 105. It is noted that these exemplars of power generation are just that, namely exemplary only. In fact, the present invention is employable in any system in which electrical energy is generated for distribution elsewhere.

Each of the indicated power sources 101-105 supplies electrical energy through electrical conductors 152 to electrical power grid 110. In turn, via electrical conductors 151, electrical energy is supplied to substations 120, as shown. Likewise, substations 120 supply electrical energy through conductors 153 to end user customers 130. It is noted, that for ease of understanding and description, only one level of substation is illustrated. In operation, any number of substation levels may be disposed between a source of electrical energy and the user or consumer of that energy.

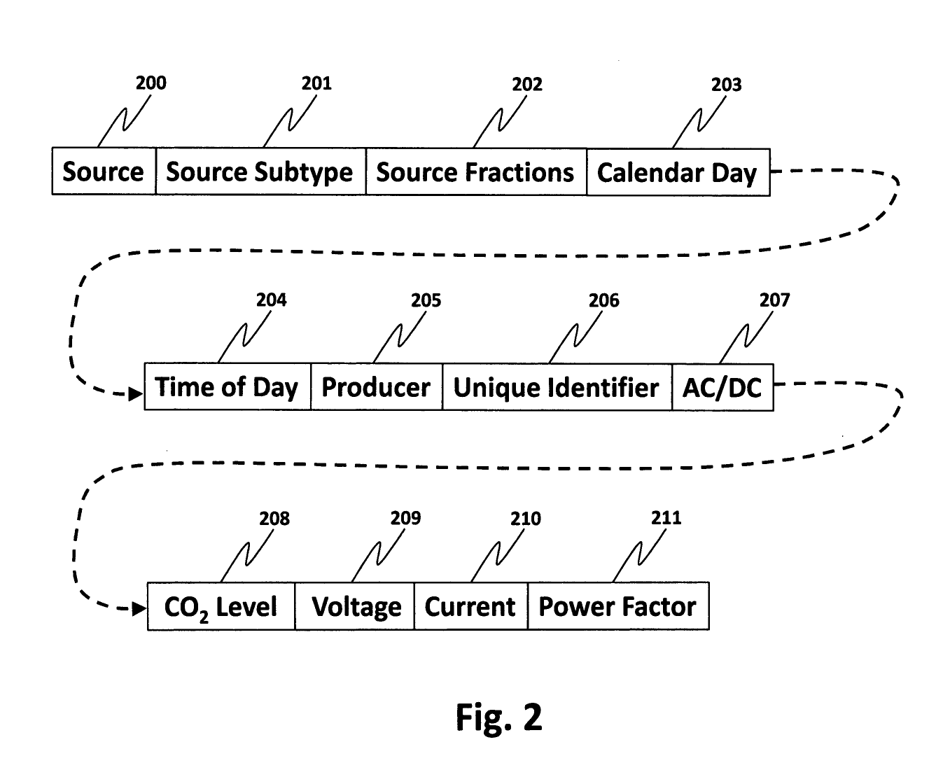

FIG. 2 illustrates the various fields of information that may be employed in conjunction with the present invention. Most importantly for the overall systemic use of the present invention, source field 200 is provided. This information field is encoded so as to identify the nature of the source of electrical energy production associated with the electrical conductor on which the present information is impressed. In particular, source field 200 provides an indication such as: coal, oil, nuclear, hydroelectric, geothermal, photovoltaic or solar/thermal. This list is intended to be illustrative and not in any way whatsoever limiting. This field may be encoded in the form of a limited number of binary digits or in a more expansive number of binary digits which actually provide a more descriptive encoding in word form (such as in ASCII or Unicoded versions). The information fields transmitted along with the electrical energy in the present invention may also include an indication of electrical energy source subtype. In particular, if the source type is indicated as being “fossil fuel,” source subtype field 201 might indicate such things as: coal, oil, natural gas, peat, anthracite, bituminous or even wood or paper pulp. Even more particularly, if source field 200 indicated oil, source subtype field 201 provides an indication of the source of the oil fuel being consumed. In particular, in such an instance source subtype field 201 could provide an indicator of the tanker from which the oil is being supplied or for that matter an indicator of the well or field of wells from which the oil has been extracted.

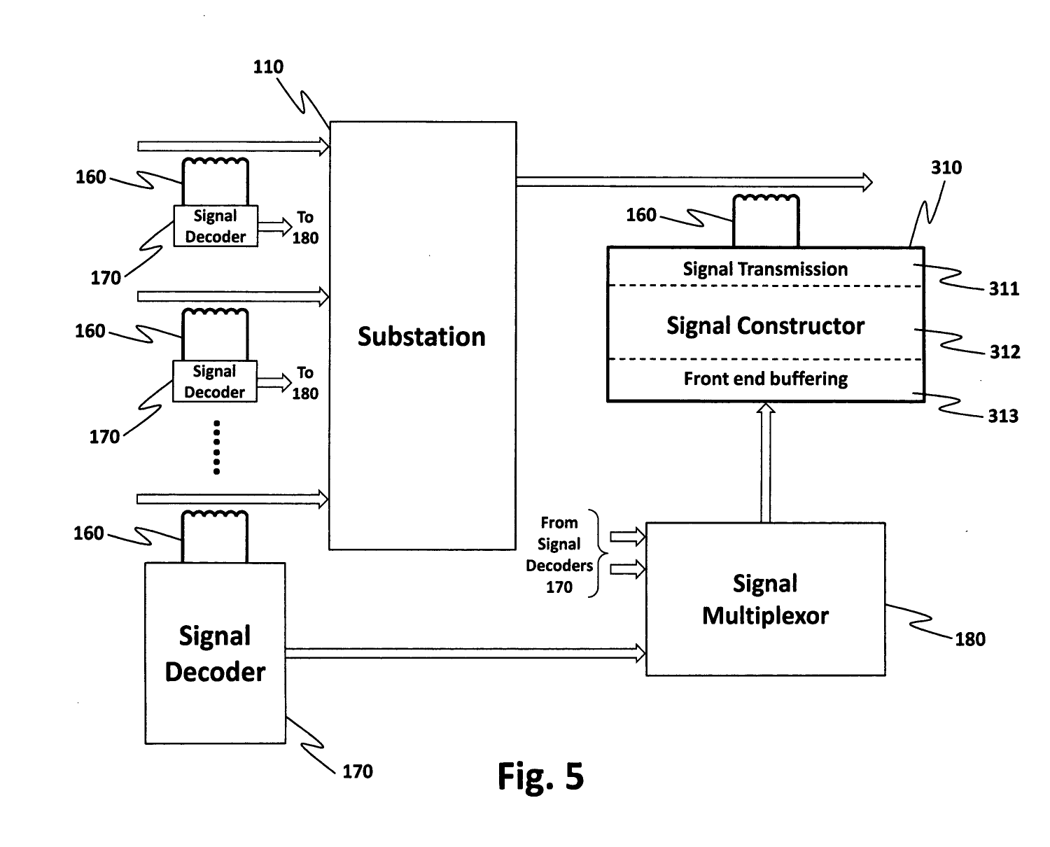

It is also important to note that the information fields illustrated in FIG. 2 are capable of providing an indication of the percentages associated with the sources of electrical energy represented on any given conductor in an electrical energy distribution system. In particular, as electrical energy reaches any given substation in the distribution tree, that energy may be provided 30% by bunker grade crude oil, 10% by geothermal, 10% by photovoltaic and 50% by coal. As this information is disseminated along the distribution path, it is adjusted at each substation which receives electrical energy from a plurality of sources and which distributes that energy to a plurality of downstream substations or end-users in the system. It is noted that at the source of electrical energy source fraction field 202 is actually set at 100%. The percentage of energy mix indicated various as electrical energy is propagated downstream from source to user. In this regard, the function of signal constructor block 312 in FIG. 5 is deemed to be particularly relevant.

It is also noted that the information fields shown in FIG. 2 preferably include date and time fields 203 and 204 respectively. These fields provide a mechanism for introducing dynamic information gathering and control. These two fields also help provide a link between dynamic information gathering particularly as it relates to local weather and atmospheric conditions and/or predicted conditions.

It is for the more noted that information fields present also preferably include a producer identification field 205 which provides a name for the company, corporation, firm, agency, authority or business entity that is associated with the initial production of energy to be provided to the energy distribution network 110. There's also preferably provided a field indicating a unique identifier 206 for the specific device or apparatus used to produce the electrical energy. Another indicator may also be employed to indicate whether or not the energy being produced has a direct current nature or an alternating current nature. See field 207. There may also be provided field 208 which indicates an estimated level of carbon dioxide production associated with the electrical energy being supplied to the grid. Additionally fields 209, 210, and 211 may be provided as an indicator of voltage, current and, power factor, respectively. Other fields may also be provided as desired or deemed appropriate and useful.

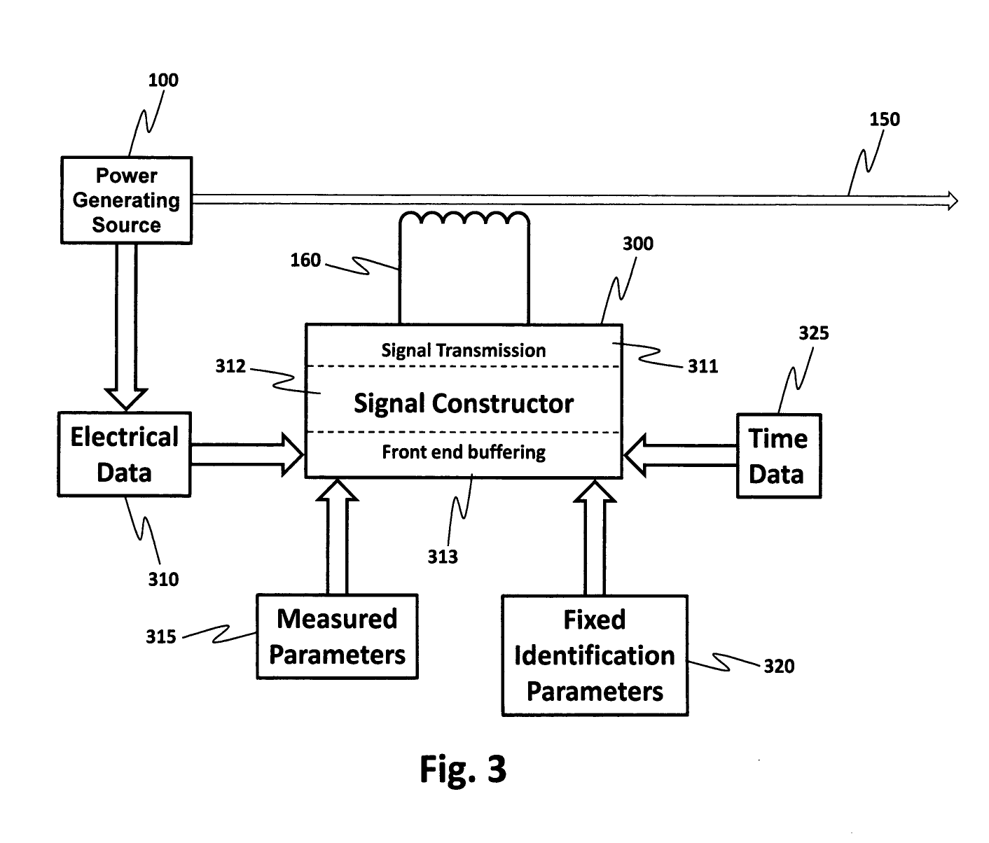

FIG. 3 illustrates the system and method of the present invention as it exists and is disposed at the source of electrical energy 100. In particular, generic electrical energy generating source 100 is shown providing energy to an electrical network via electrical conductor 150. Power generating source 100 also provides electrical data 310 to signal constructor 300 and more particularly to front end buffering portion 313 thereof. In particular, electrical data 310 comprises such information as voltage level, current level, power factor and AC/DC indications for insertion into information fields 209, 210, 211, and 207, respectively, as shown in FIG. 2. Signal constructor 300 also receives time and date information 325 for insertion into information fields 204 and 203, respectively, as seen in FIG. 2. Signal constructor 300 also includes the capacity for receiving measured parameters such as an indication of the current level of carbon dioxide production by electrical power source 100. Like the other data shown herein this information is provided to front end buffering portion 313 of signal constructor 300.

Most importantly for the present invention, signal constructor 300, and in particular the front end buffering portion 313 thereof, receives fixed identification parameters 320. These identification parameters include the nature of electrical power generating source 100 (solar, fossil, renewable, geothermal, nuclear, etc., etc.). This information also includes identifiers for source subtype field 201. This information is buffered in the front end of signal constructor 300. It is also noted that this information is preferably protected by an outside controlled security function which prevents a given utility from falsely indicating that its electrical energy source is, say renewable, when it is not. For this functionality see FIG. 5. This fixed identification information not only preferably includes power generating identification information but also an identifier indicating the particular generating unit and the entity which owns or is responsible for the operation of the unit. As above, this information is provided to the front end of signal constructor 300. Signal constructor 300 includes specific signal construction portion 312 which assembles the incoming data into a single digital field which is provided to signal transmitting portion 311 of constructor 300. Through inductively coupled circuits 160 this information is transmitted on energy carrying conductor 150 in accordance with well known power line communication protocols.

It is particularly noted here that power line communication technology is a well known art. In particular, U.S. Pat. No. 7,339,466 issued to Mansfield et al. on Mar. 4, 2008 based upon an application filed on Jan. 11, 2006 describes a power line communication system in which identification between subscribing members is provided. It is noted however that there is no indication of identification of power sources. It is, nonetheless, one example of a power line communication system, albeit a relatively local one. Attention is also drawn to U.S. Pat. No. 6,281,784 issued to Redgate et al. on Aug. 28, 2001 based on an application filed on Feb. 26, 1999. This patent also describes powerline communication systems. However, as above, the patent does not describe identification of electrical energy sources as part of the information transferred.

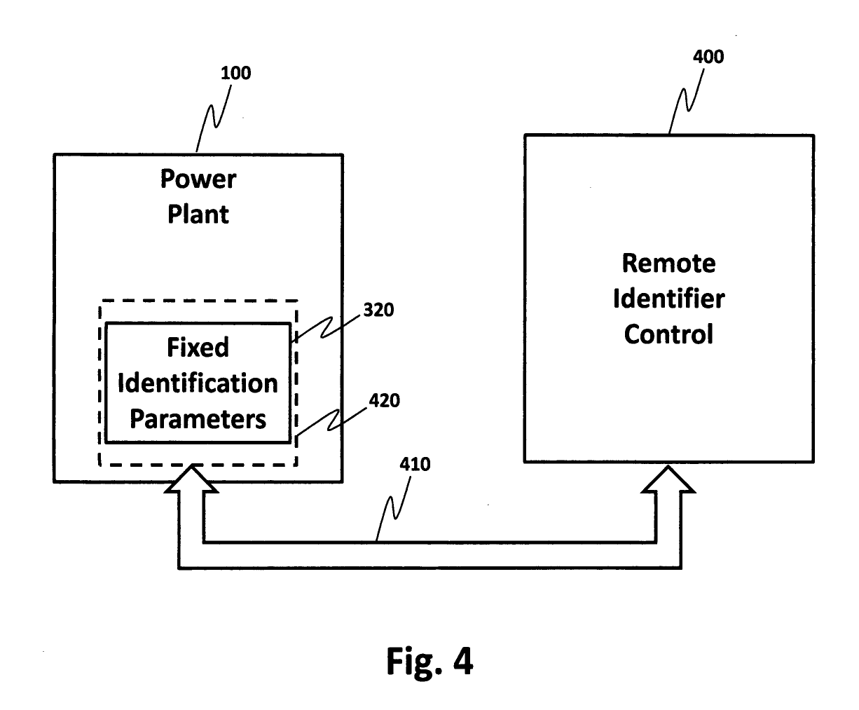

The present invention also provides a mechanism for the secure control of the impressing of source identifying information onto electrical conductors 150, 151 and 153. In particular, as shown in FIG. 4, fixed identification parameters 320 are disposed inside of secure layer 420. This layer is accessible from remote location 400 from which identifier control is provided. Connection to remote location 400 is preferably provided over a secure Internet connection 410. In this manner local operators of power plant 100 are prevented from changing the source identifier once it has been set. Typically control of fixed identification parameters 320 is provided via a municipal, governmental or other trusted authority.

The present invention also contemplates the situation in which electrical signals carrying power and information arrive at substation 110 from a plurality of sources, as seen in FIG. 1. At a substation in inductive coupling 160 is employed to sense information signals impressed upon the electrical conductors and to decode them so as to provide in binary form, the same sort of information that is seen in the fields shown in FIG. 2. Decoders 170 extract the digital information arriving at substation 110 and provide this to signal multiplexor 180. Multiplexer 180 receives a plurality of signals and sends them on to front end buffering at 313 of signal constructor 310. Based upon indications of voltage current and power factor and/or various combinations of these indicators, as well as indicators that are discernible by substation 110 itself, signal constructor 312 generates a new information field similar to that shown in FIG. 2. However, in contrast to earlier information generation, signal constructor 312 takes into account the actual energy levels being supplied to substation 110 from its various input sources. Unlike earlier field 202, as discussed above, there is no longer likely to be any 100% indicator levels since it is expected that substation 110 is receiving electrical energy from a plurality of different sources. Signal constructor 312 generates indications showing specific subfields as percentages of energy being supplied from different power sources as described above (30% by bunker grade crude oil, 10% by geothermal, 10% by photovoltaic and 50% by coal, for example). Having thus adjusted the contents of the information fields shown in FIG. 2, signal transmission circuits 311 together with inductive coupling 160 impressed the new signal upon the downstream conductors 153 exiting substation 110. To avoid interference with any incoming information signals, signal transmission accomplished via circuits 311 is provided at a different carrier frequency and/or with different encoding characteristics. Alternatively, as the information signal progresses down through the electrical energy distribution tree the information field structure is enlarged at each substation to accommodate the additional data. Accommodation for growing information fields may also be provided in an initial information field structure whose size is sufficient to accommodate growth as information is propagated through a plurality of substations.

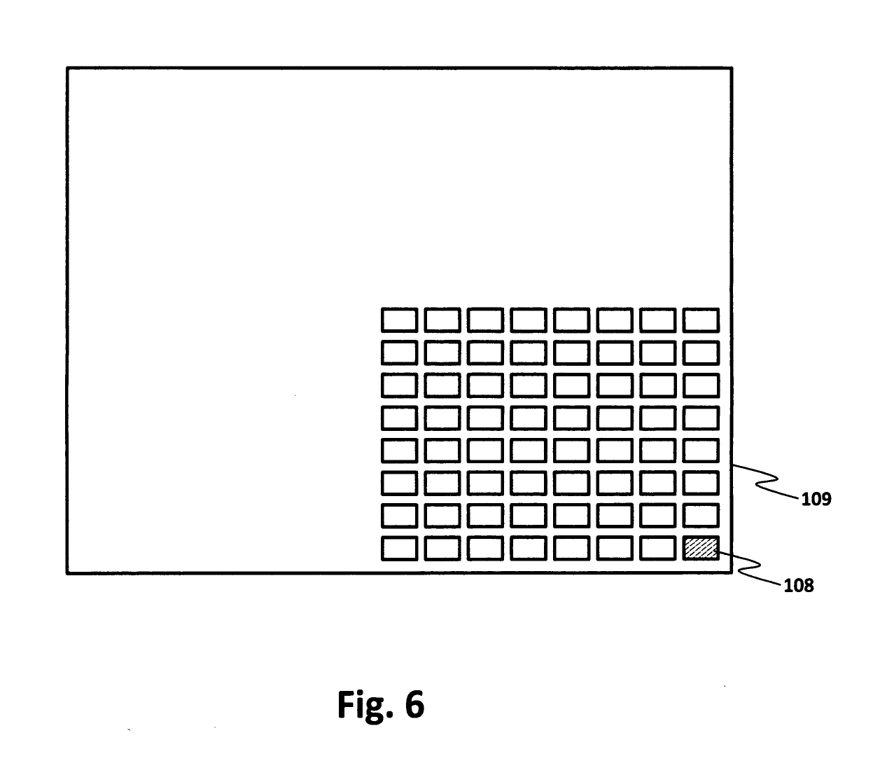

FIG. 6 is provided herein to point out the fact that the present invention specifically accommodates the identification of individual electrical energy sources. In particular, FIG. 6 illustrates an exemplary photovoltaic structure 109 in which portion 108 thereof is dedicated to circuitry whose sole purpose is the transmission of signal level information on the same set of electrical conductors used as an output from photovoltaic panel 109. Circuitry 108 may also include a GPS (Global Positioning Satellite) receiving device which encodes latitude and longitude information to be transmitted along with source identification. In this regard, it is also noted that the field structure shown in FIG. 2 is also easily modified to incorporate information provided from a GPS circuit.

The description provided above emphasizes the transmission of electrical energy by means of electrical conductors. However, it is noted, that the present invention is also employable in situations in which electrical energy is transmitted via microwave radiation. In particular, it is noted that an orbital-based microwave energy transmission satellite system capable of transmitting microwave radiation to earth-based receivers is also capable of impressing upon the power signal an information signal relating to the generation of electrical energy in Earth orbit. In such cases, parameters such as altitude, orientation, solar distance (a seasonal factor) and time of day become useful information to transmit along with the power signal.

Should the transmission of electrical energy via a plasma conductor be employed, it is seen that the simultaneous transmission of electrical energy source identifying information may also be provided. The present invention is also applicable in those situations in which the transmission of electrical energy occurs via a superconductor. Furthermore, it in terms of the present invention it is irrelevant as to whether the transmission line for electrical energy is above ground or is provided through an underground network, even if transmission is only partially underground. In short, the present invention is not limited to the transmission of electrical energy by means of metallic conductors.

The present invention contemplates the simultaneous transmission of electrical energy source identifying information as provided on a unit by unit basis with the capability of retrofitting existing units with information signal transmission devices. In particular, the present invention is not limited to source identification being associated with large multi-megawatt generating plants. The present invention is also intended to cover source identification down to the level of an individual energy generating unit, a solar panel, for example, even if that panel is present on a minivan or other vehicle. Accordingly, the present invention also contemplates the situation in which automobiles and other vehicles are provided with solar photovoltaic panels which not only operate to provide a certain level of energy to the vehicles on which they are mounted, but which also operate to supply power to the power grid. As electrical refueling stations for hybrid and totally electric vehicles become more commonplace, each vehicle is provided with its own unique identifier so that, as it feeds back energy to the electrical grid, the source of that energy is identified.

The present invention also particularly contemplates the situation in which vehicles having a fuel cell as an energy source are employed as sources which are capable of supplying energy to an electrical energy distribution network or grid. As indicated above, such vehicles are provided with their own unique identifying number which is transmitted along with the electrical energy that they supply to the grid when they are so connected. This is in keeping with the notion that an economy based in whole or in part upon energy as a commodity of exchange, and in particular using hydrogen as a fuel, lends itself to the situation in which automobiles and other related vehicles are capable of operating on their own as a source of electrical energy as opposed to merely being a sink for it. Such fuel cell-based vehicles are capable of supplying household electrical energy as well as electrical energy to the grid and to the vehicle itself. This becomes more significant as the capability for local or homeowner generation of hydrogen becomes more commonplace. It is also contemplated that, by means of the existence of a unique electrical energy source identifying datum, it then becomes possible to communicate with such a vehicle and in response to a high energy demand, controlling the energy source for that vehicle (be it a solar roof panel or on board fuel cell) so as to direct the vehicle to supply energy to the grid to which it is connected. If it is connected to the grid, such a control signal may be sent to the vehicle over the grid connection. Such a control signal may also be sent to the vehicle wirelessly via an Internet connection.

The present invention provides a number of significant advantages most notably in the area of energy production and distribution monitoring. The present invention makes it possible for individual homeowners and businesses to determine where their electrical energy is being generated that is, to determine the nature of the energy mechanism being used to generate their electricity. This monitoring capability is not only available to individuals and end-user consumers, it is also available to various regional authorities and/or other watchdog groups. Monitoring is capable of being performed by various entities including states, regions, counties, countries, solar energy generating districts, power companies, the power industry itself and even the United Nations. The present invention thus provides an information feedback loop that makes a smart grid that much smarter.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

What is claimed is:

1. A method of providing electrical energy:
generating said electrical energy;
transmitting said electrical energy from a source to a destination via an electrical transmission network;
specifying an energy source indicium for said generated electrical energy; and
transmitting said indicium on said electrical transmission network along with said energy.

2. The method of claim 1 in which said indicium indicates that said electrical energy is derived from a source selected from the group consisting of: solar, wind, geothermal, biofuel, coal, oil, natural gas, nuclear fission, nuclear fusion and tidal.

3. The method of claim 1 in which, in addition to said energy source indicium, further items of information are included, said items being selected from the group consisting of: date, time of day, energy source subgroup, voltage, current, power factor, a source fraction, carbon dioxide level, producing entity, device identifier, an indication that said electrical energy is DC and an indication that said electrical energy is AC.

4. The method of claim 1 in which said energy source indicium is securely specified.

5. The method of claim 1 in which said energy source indicium is securely specified from a remote location.

6. The method of claim 1 in which said energy source indicium is securely specified from a remote location via an Internet connection.

7. An electrical energy generating facility comprising:
a source of electrical energy;
electrical conductors for transmitting said electrical energy through a distribution network;
a power line communication device for impressing signal level information on said electrical conductors; and
a source of information providing an indicium identifying the nature of said source of electrical energy, said source of information coupled to said powerline communication device in a manner in which said signal level information includes said indicium, whereby electrical energy distributed on said network includes an indication of the source of generation for said electrical energy.

8. The facility of claim 7 in which said nature of said source of electrical energy is selected from the group consisting of: solar, wind, geothermal, biofuel, coal, oil, natural gas, nuclear fission, nuclear fusion and tidal.

9. The facility of claim 7 in which, in addition to said indicium, further items of information are included on said signal, said items being selected from the group consisting of: date, time of day, energy source subgroup, voltage, current, power factor, a source fraction, carbon dioxide level, producing entity, device identifier, an indication that said electrical energy is DC and an indication that said electrical energy is AC.

10. A substation facility for electrical energy distribution, said substation comprising:
a plurality of input electrical conductors for supplying electrical energy to said substation facility;
at least one output electrical conductor for supplying electrical energy from said substation facility;
a plurality of power line communication receiving devices for decoding information signals provided on said input electrical conductors;
a multiplexor for receiving said decoded information from said plurality of electrical conductors and for buffering and packaging said information; and
powerline communication transmitting devices for transmitting said buffered and packaged information for transmittal on said at least one output electrical conductor.

11. The substation facility of claim 10 further including processing means for determining fractional portions of energy associated with each of said input electrical conductors.

12. An electrical energy generating apparatus, having output conductors, and which includes a powerline communication transmitter for impressing upon said output conductors an indication of the nature of the source of electrical energy associated with said apparatus.

13. The apparatus of claim 12 in which the nature of said source of electrical energy is selected from the group consisting of: solar, wind, geothermal, biofuel, hydrogen, fuel cell, coal, oil, natural gas, nuclear fission, nuclear fusion and tidal.

14. The apparatus of claim 12 in which said powerline communication transmitter is retrofitted to said electrical energy generating apparatus.
